(19) United States
(12) Patent Application Publication
(10) Pub. No.: US 2003/0173420 A1
(43) Pub. Date: Sep. 18, 2003

(54) Drill sprayer

(76) Inventor: John D. Hanson, San Diego, CA (US)

Correspondence Address: JOHN D. HANSON, 2727 DEANZA ROAD K18, SAN DIEGO, CA, 92109, US

(21) Appl. No.: 10/098,061

(22) Filed: Mar. 15, 2002

(51) Int. Cl. B05B 7/32

(52) U.S. Cl. 239/337

(57) ABSTRACT

An improved liquid sprayer having a container (12) with a handle (14). A a supply tube (16) extends into the container (12) and upward through a container cap (18) and a container cap attachment (20) and into a pump inlet (22) which is open to a pump (24). Adjacent to the front of pump (24) is a pump outlet (26) and a nozzle (27). Adjacent to the rear of pump (24) is a pump drive (32) which removably communicates with a pump drive socket (34) affixed to a conventional rechargeable drill (36). The drill sprayer (10) can be removably attached to the container (12) which then is refilled and reused. Alternately the drill sprayer (10) can be permanently affixed to the container (12) and therefore disposable.

### CROSS-REFERENCE TO RELATED APPLICATIONS

Not applicable.

### BACKGROUND—FIELD OF INVENTION

This invention relates to hand-held battery operated fluid dispensers, specifically to an improved liquid sprayer.

### BACKGROUND—DESCRIPTION OF PRIOR ART

Hand-held motorized fluid dispensers are known and are shown for example in U.S. Pat. No. 4,154,375 to Bippus, U.S. Pat. No. 5,150,841 to Silvenis et al, and U.S. Pat. No. 5,716,007 to Nottingham et al. In such prior dispensers, an electric motor is selectively connected to a battery source. When energized the motor operates a pump mechanism by which fluid in a supply container associated with the dispenser is pumped trough a discharge opening. Such prior dispensers have a number of disadvantages in that they are of low power, low torque, and short battery life. They therefore are of very limited output volume, spray velocity, distance of projection and area of coverage. They have many elements and would be costly to manufacture and repair. Prior art dispensers are complex. This complexity would render them inoperable without their own motor and housing, pump and housing, and a container specific to the dispenser. A continuous spray stream is often not obtainable with these known systems. They would not be disposable due to the high cost of manufacture and therefore would not be tamperproof or childproof Lastly, they often involve the mixing of hazardous chemicals and thus present potential liability.

### SUMMARY

In accordance with the present invention a sprayer which dispenses fluids from a container using a conventional drill.

### OBJECTS AND ADVANTAGES

Accordingly, besides the objects and advantages of the drill sprayer described above, several other objects and advantages are:

(a) to provide a sprayer which is permanently affixed to a container and disposable;

(b) to provide a sprayer which eliminates the mixing of hazardous chemicals because it is disposable;

(c) to provide a sprayer which is tamperproof and childproof;

(d) to provide a sprayer of high power, torque, and battery life;

(e) to provide a sprayer of high volume of spray and velocity of spray;

(f) to provide a sprayer with maximum distance of projection and area coverage;

(g) to provide a sprayer which sprays rapidly and efficiently, reducing time and labor,

(h) to provide a sprayer which produces a continuous stream of spray without pulsing;

(i) to provide a sprayer that is inexpensive to manufacture with a minimum of elements and of all plastic construction; and

(j) to provide a sprayer that dispenses liquid using any conventional drill.

Further objects and advantages will become apparent from the specification and drawings.

### BRIEF DESCRIPTION OF THE DRAWINGS

FIG. 1 is a side view of the drill sprayer.

FIG. 2 is a front view of the drill sprayer.

FIG. 3 is a rear view of the drill sprayer.

### REFERENCE NUMERALS IN DRAWINGS

10 drill sprayer

12 container

14 handle

16 supply tube

18 container cap

20 container cap attachment

22 pump inlet

24 pump

26 pump outlet

27 nozzle

28 front half-shell

29 back half-shell

30 pump seal

32 pump drive

34 pump drive socket

36 drill

### DESCRIPTION PREFERRED EMBODIMENT

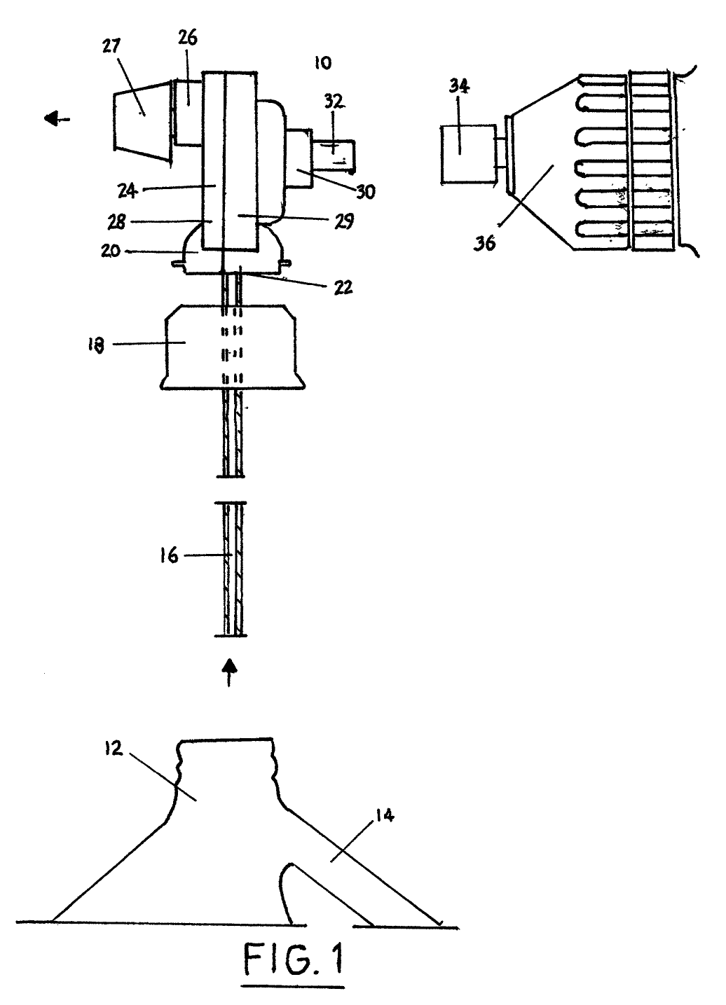

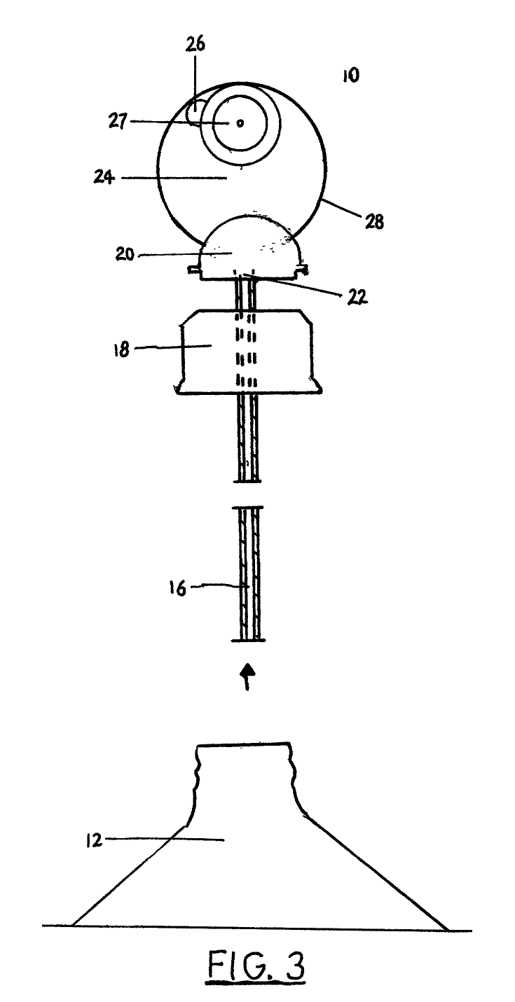

With reference now to the drawings, and in particular FIGS. 1 through 3 thereof, a new drill sprayer generally designated by the reference numeral 10 will be described.

The drill sprayer designated as numeral 10, includes a container 12 having a handle 14. A supply tube 16 extends upward from container 12 through a container cap 18 and a container cap attachment 20. The communication of container cap 18 and container cap attachment 20 allows 360 degree rotation of container 12 relative to a pump 24. In the preferred embodiment container cap 18 is permanently affixed to container 12. Atmospheric pressure equalization is provided by a vent diaphragm (not shown) in container cap 18 and is well known in current trigger sprayers. Supply tube 16 inserts into a pump inlet 22 which is open to pump 24. In FIGS. 1 through 3 pump is of centrifugal design. Other well known pump types could be employed including gear, piston, vane, diaphragm or peristaltic. Of simple construction, pump 24 consists of a front half-shell 28 including a pump outlet 26 and a nozzle 27, and a back half-shell including pump inlet 22, a pump seal 30, and a pump drive 32. In the preferred embodiment front half-shell 28 and back half-shell 29 are permanently bonded one to the other and the drill sprayer 10 is of all plastic construction.

Also included is a conventional drill 36 having an L-shaped configuration. Such drills are well known and are equipped with an upper extent having a motor mounted therein. A lower extent of drill 36 takes the shape of a gripping member with a trigger (not shown). Drill 36 has a pump drive socket 34 securely affixed which is of well known hex-head design and of correct size for removably engaging pump drive 32

### DESCRIPTION AND OPERATION OF ALTERNATIVE EMBODIMENTS

An additional embodiment is to have drill sprayer 10 removably attached to container 12 to allow refilling and reuse. Additionally, there are various possibilities with regard to drill sprayer 10, drill 36, supply tube 16, container 12 and their position one relative to the other. One skilled in the art would see supply tube 16 could be of a length of several meters with drill sprayer 10 affixed to one end and container 12 at the other. This embodiment gives the user great mobility and allows a large container 12 to be placed on the ground or any suitable surface negating lifting and carrying. Alternately, drill 36 could be attached removably to container 12 taking the function of handle 14. Supply tube 16 in this embodiment would be of adequate length and structure to be of the spraying wand configuration found on current hand-pump pressurized sprayers.

### OPERATION—FIGS. 1, 2, 3

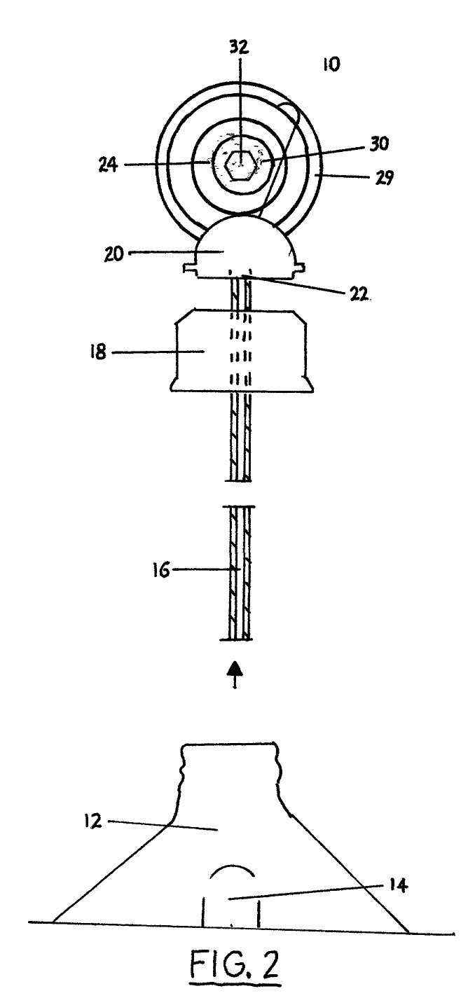

The manner of using drill sprayer 10 is to grasp container 12 by handle 14 with one hand, and drill 36 with the other Drill 36 with pump drive socket 34 are then aligned to removably engage pump drive 32 which in FIG. 2 is of hex-head design. Upon energizing drill 36, rotational energy is transmitted to pump 24 and a pressure differential of several bars is created. Low pressure is created at pump inlet 22 and suction draws fluid through supply tube 16 and into pump 24. High pressure is created at pump outlet 26 and fluid is forcefully sprayed through nozzle 27.

Not shown in the drawings and well known to those skilled in the art are three operational features found in current manual trigger sprayers. First, nozzle 27 is adjustable from the closed position, through a spray position, and to a stream position. Second, container 12 is rotatable 360 degrees relative to pump 24 through the communication of the container cap 18 and the container cap attachment 20. Finally, container 12 is vented to the atmosphere through a vent diaphragm (not shown) in container cap 18.

As to further discussion of the manner of usage and operation of the present sprayer, the same should be apparent from the above description. Accordingly, no further discussion relating to the manner of usage and operation will be provided.

With respect to the above description then, it is to be realized that the optimum dimensional relationships for the parts of the sprayer, to include variations in size, materials, shape, form, function and manner of operation, assembly and use, are deemed readily apparent and obvious to one skilled in the art, and all equivalent relationships to those illustrated in the drawings and described in the specification are intended to be encompassed herein.

Therefore, the foregoing is considered as illustrative only of the principles of the liquid dispenser. Further, since numerous modifications and changes will readily occur to those skilled in the art, it is not desired to limit the dispenser to the exact construction and operation shown and described, and accordingly, all suitable modifications and equivalents may be resorted to, falling within the scope of the invention.

I claim:

1. A fluid sprayer comprising, means providing a supply container, means providing a pump mounted on said supply container, means providing a pump inlet connecting said pump with fluid in said supply container, means providing a pump outlet connecting said pump with a nozzle, means providing rotational energy to said pump, wherein said rotational energy is provided by a conventional drill.

2. The fluid sprayer of claim 1 wherein said supply container has a handle affixed for grasping and preventing rotation of said supply container relative to said conventional drill.

3. The fluid sprayer of claim 1 wherein said pump is of centrifugal design.

4. A fluid sprayer comprising, means providing a supply container, means providing a pump mounted on said supply container, means providing a pump inlet connecting said pump with fluid in said supply container, means providing a pump outlet connecting said pump with a nozzle, means providing rotational energy to said pump using a conventional drill, means providing a pump drive socket affixed to said conventional drill, means providing a pump drive communicating with said pump, wherein said pump drive socket and said pump drive are of hex-head design and of correct size for selectively connecting and disconnecting with each other.

5. The fluid sprayer of claim 4 wherein said fluid sprayer, excluding said conventional drill, is of all plastic construction.

6. The fluid sprayer of claim 4 wherein said fluid sprayer, excluding said conventional drill, is disposable.

7. The fluid sprayer of claim 4 wherein said pump comprises a front half-shell and a back half-shell permanently bonded together.

8. A fluid sprayer comprising:
a. a supply container,
b. a pump mounted on said container,
c. a conventional drill for controllably and removably coupling rotational energy from said conventional drill to said pump, wherein the improvement comprises the use of said conventional drill to provide rotational energy.
